(19) United States
(12) Patent Application Publication
(10) Pub. No.: US 2025/0287238 A1
(43) Pub. Date: Sep. 11, 2025

(54) COMMUNICATION METHOD AND APPARATUS

(71) Applicant: SPREADTRUM COMMUNICATIONS (SHANGHAI) CO., LTD., Shanghai (CN)

(72) Inventors: Huayu ZHOU, Shanghai (CN); Sicong ZHAO, Shanghai (CN); Zhenzhu LEI, Shanghai (CN); Zhengang PAN, Shanghai (CN)

(73) Assignee: SPREADTRUM COMMUNICATIONS (SHANGHAI) CO., LTD., Shanghai (CN)

(21) Appl. No.: 18/859,763

(22) PCT Filed: Apr. 20, 2023
(86) PCT No.: PCT/CN2023/089497

§ 371 Date: Oct. 24, 2024

(30) Foreign Application Priority Data
Apr. 24, 2022 (CN) 202210435960.5

(51) Int. Cl. H04W 24/08

(52) U.S. Cl. CPC H04W 24/08

(57) ABSTRACT

Embodiments of the present disclosure provide a communication method and apparatus, relating to the field of communication technologies. The method includes performing measurement based on a measurement indication. The method provided in the embodiments of the present disclosure helps improve efficiency of switching between cells.

### CROSS-REFERENCE TO RELATED APPLICATIONS

The present disclosure is a continuation of International Application No. PCT/CN2023/089497, filed on Apr. 20, 2023, which claims priority to Chinese Patent Application No. 202210435960.5, filed with the China National Intellectual Property Administration on Apr. 24, 2022 and entitled “COMMUNICATION METHOD AND APPARATUS”. The disclosures of the aforementioned applications are hereby incorporated by reference in their entireties.

### TECHNICAL FIELD

Embodiments of the present disclosure relate to the field of communication technologies, and in particular, to a communication method and apparatus.

### BACKGROUND

Because network energy saving (NES) can reduce operating costs and is environmentally friendly, NES is a concern of operators and equipment vendors. For example, in a 5th-generation (5G) network, because there are many spectrum resources, including frequency bands such as 1 GHz, 2 GHZ, 4 GHZ, 6 GHZ, and 26 GHz, cells corresponding to some frequency bands (such as 4 GHz, 6 GHZ, and 26 GHZ) can be deactivated if possible when a network load is low and activated when needed, to implement NES.

However, to support access and mobility of a terminal device, the terminal device needs to access the deactivated cells in some scenarios. Therefore, before being accessed, the deactivated cells need to be activated. In this way, the terminal device can complete measurement and report measurement results such that the terminal device can access the deactivated cells. Activating the deactivated cells inevitably increases energy consumption of the network. Therefore, it is challenging to balance NES and rapid switching to the deactivated cells.

### SUMMARY

Embodiments of the present disclosure provide a communication method and apparatus.

According to a first aspect, the embodiments of the present disclosure provide a communication method including performing measurement based on a measurement indication.

The embodiments of the present disclosure help improve efficiency of switching between cells.

In a possible implementation, the measurement indication is carried in a wake-up signal, a paging indication, a page, a message 2 (Msg2), a message 4 (Msg4), or a message B (MsgB).

In a possible implementation, the measurement indication is carried in a physical downlink control channel (PDCCH).

In a possible implementation, the PDCCH is a PDCCH order.

In a possible implementation, the measurement indication is carried in radio resource control (RRC) signaling.

In a possible implementation, the measurement indication is carried in a media access control control element (MAC CE).

In a possible implementation, the method further includes performing measurement based on a measurement object configuration.

In a possible implementation, the measurement object configuration includes a cell identifier or a physical cell identifier.

In a possible implementation, the measurement object configuration includes a cell frequency.

In a possible implementation, the measurement object configuration is carried in system information (SI).

According to a second aspect, the embodiments of the present disclosure further provide a communication method including determining a starting time at which a measurement reference signal is valid.

In a possible implementation, said determining the starting time at which the measurement reference signal is valid includes determining, based on a reference signal validity indication, the starting time at which the measurement reference signal is valid.

In a possible implementation, said determining, based on the reference signal validity indication, the starting time at which the measurement reference signal is valid includes:
if the reference signal validity indication indicates that there is a time gap, determining that the starting time at which the measurement reference signal is valid is a time at which a first measurement reference signal is transmitted after the time gap; or
if the reference signal validity indication indicates that there is no time gap, determining that the starting time at which the measurement reference signal is valid is a time at which the first measurement reference signal is transmitted.

In a possible implementation, the time gap is predefined, or the time gap is carried in a semi-static configuration, or the time gap is carried in the reference signal validity indication, or the time gap is indicated in the reference signal validity indication in candidate values. The candidate values are carried in the semi-static configuration.

In a possible implementation, the reference signal validity indication is carried in a wake-up signal, a paging indication, a page, a Msg2, a Msg4, or a MsgB.

In a possible implementation, the reference signal validity indication is carried in a PDCCH.

In a possible implementation, the PDCCH is a PDCCH order.

In a possible implementation, the reference signal validity indication is carried in RRC signaling.

In a possible implementation, the reference signal validity indication is carried in a MAC CE.

In a possible implementation, said determining the starting time at which the measurement reference signal is valid includes:
determining, based on a measurement indication, that the starting time at which the measurement reference signal is valid is a time at which a first measurement reference signal is transmitted after a time gap.

In a possible implementation, the time gap is predefined, or the time gap is carried in a semi-static configuration.

According to a third aspect, the embodiments of the present disclosure further provide a communication method including reporting a measurement result.

In a possible implementation, said reporting the measurement result includes:
reporting the measurement result through a physical random access channel (PRACH) or a message A (MsgA).

In a possible implementation, said reporting the measurement result includes:
reporting the measurement result through a message 3 (Msg3) or a MsgB.

In a possible implementation, said reporting the measurement result includes:
reporting the measurement result through a message 5 (Msg5) or a message C (MsgC).

In a possible implementation, said reporting the measurement result includes:
reporting the measurement result through uplink control information (UCI).

In a possible implementation, said reporting the measurement result includes:
reporting the measurement result through radio RRC signaling.

In a possible implementation, said reporting the measurement result includes:
reporting the measurement result through a MAC CE.

According to a fourth aspect, the embodiments of the present disclosure further provide a communication method, including:
transmitting a measurement indication.

In a possible implementation, said transmitting the measurement indication includes:
transmitting the measurement indication through a wake-up signal, a paging indication, a page, a Msg2, a Msg4, or a MsgB.

In a possible implementation, said transmitting the measurement indication includes:
transmitting the measurement indication through a PDCCH.

In a possible implementation, the PDCCH is a PDCCH order.

In a possible implementation, said transmitting the measurement indication includes:
transmitting the measurement indication through RRC signaling.

In a possible implementation, said transmitting the measurement indication includes:
transmitting the measurement indication through a MAC CE.

In a possible implementation, the method further includes:
transmitting a measurement object configuration.

In a possible implementation, the measurement object configuration includes a cell identifier or a physical cell identifier.

In a possible implementation, the measurement object configuration includes a cell frequency.

In a possible implementation, the measurement object configuration is carried in SI.

According to a fifth aspect, the embodiments of the present disclosure further provide a communication method, including:
indicating a time at which a measurement reference signal is valid.

In a possible implementation, said indicating the time at which the measurement reference signal is valid includes:
indicating, through a reference signal validity indication, the time at which the measurement reference signal is valid.

In a possible implementation, said indicating, through the reference signal validity indication, the starting time at which the measurement reference signal is valid includes:
if the reference signal validity indication indicates that there is a time gap, indicating that the starting time at which the measurement reference signal is valid is a time at which a first measurement reference signal is transmitted after the time gap; or
if the reference signal validity indication indicates that there is no time gap, indicating that the starting time at which the measurement reference signal is valid is a time at which the first measurement reference signal is transmitted.

In a possible implementation, the time gap is predefined, or the time gap is carried in a semi-static configuration, or the time gap is carried in the reference signal validity indication, or the time gap is indicated in the reference signal validity indication in candidate values. The candidate values are carried in the semi-static configuration.

In a possible implementation, the reference signal validity indication is carried in a wake-up signal, a paging indication, a page, a Msg2, a Msg4, or a MsgB.

In a possible implementation, the reference signal validity indication is carried in a PDCCH.

In a possible implementation, the PDCCH is a PDCCH order.

In a possible implementation, the reference signal validity indication is carried in RRC signaling.

In a possible implementation, the reference signal validity indication is carried in a MAC CE.

In a possible implementation, said indicating the starting time at which the measurement reference signal is valid includes:
indicating, through a measurement indication, that the starting time at which the measurement reference signal is valid is a time at which a first measurement reference signal is transmitted after a time gap.

In a possible implementation, the time gap is predefined, or the time gap is carried in a semi-static configuration.

According to a sixth aspect, the embodiments of the present disclosure further provide a communication method including receiving a measurement result.

In a possible implementation, said receiving the measurement result includes:
receiving the measurement result through a PRACH or a MsgA.

In a possible implementation, said receiving the measurement result includes:
receiving the measurement result through a Msg3 or a MsgB.

In a possible implementation, said receiving the measurement result includes:
receiving the measurement result through a Msg5 or a MsgC.

In a possible implementation, said receiving the measurement result includes:
receiving the measurement result through UCI.

In a possible implementation, said receiving the measurement result includes:
receiving the measurement result through RRC signaling.

In a possible implementation, said receiving the measurement result includes:
receiving the measurement result through a MAC CE.

According to a seventh aspect, the embodiments of the present disclosure provide a communication apparatus, including a processor and a memory. The memory is configured to store a computer program. The processor is configured to execute the computer program to perform the communication method according to the first to third aspects.

According to an eighth aspect, the embodiments of the present disclosure further provide a communication apparatus, including a processor and a memory. The memory is configured to store a computer program. The processor is configured to execute the computer program to perform the communication method according to the fourth to sixth aspects.

According to a ninth aspect, the embodiments of the present disclosure provide a computer-readable storage medium. The computer-readable storage medium stores a computer program. When the computer program is executed on a computer, the computer is enabled to perform the communication method according to the first to sixth aspects.

According to a tenth aspect, the embodiments of the present disclosure provide a computer program product. The computer program product includes a computer program. When the computer program is executed by a computer, the computer is enabled to perform the communication method according to the first to sixth aspects.

In a possible implementation, the program in the tenth aspect may be completely or partially stored on a storage medium packaged with a processor or may be completely or partially stored on a memory not packaged with a processor.

According to an eleventh aspect, the embodiments of the present disclosure provide a communication apparatus, including one or more functional modules. The one or more functional modules are configured to perform any communication method according to the first to third aspects.

According to a twelfth aspect, the embodiments of the present disclosure provide a communication apparatus, including one or more functional modules. The one or more functional modules are configured to perform any communication method according to the fourth to sixth aspects.

According to a thirteenth aspect, a communication system is provided, including the communication apparatus configured to perform any method according to the seventh aspect and the communication apparatus configured to perform any method according to the eighth aspect.

The communication apparatus in the seventh and eleventh aspects may be a chip or a terminal device. The communication apparatus in the eighth and twelfth aspects may be a chip or a network device.

### BRIEF DESCRIPTION OF DRAWINGS

FIG. 1 is a schematic diagram of a network architecture of a communication system according to an embodiment of the present disclosure;

FIG. 2 is a schematic flowchart of an embodiment of a communication method according to the present disclosure;

FIG. 3 is a schematic flowchart of another embodiment of a communication method according to the present disclosure;

FIG. 4 is a schematic flowchart of another embodiment of a communication method according to the present disclosure;

FIG. 5 is a schematic flowchart of another embodiment of a communication method according to the present disclosure;

FIG. 6 is a schematic diagram of an embodiment of a communication apparatus according to the present disclosure;

FIG. 7 is a schematic diagram of another embodiment of a communication apparatus according to the present disclosure;

FIG. 8 is a schematic diagram of another embodiment of a communication apparatus according to the present disclosure;

FIG. 9 is a schematic diagram of another embodiment of a communication apparatus according to the present disclosure;

FIG. 10 is a schematic diagram of another embodiment of a communication apparatus according to the present disclosure;

FIG. 11 is a schematic diagram of another embodiment of a communication apparatus according to the present disclosure; and

FIG. 12 is a schematic diagram of an electronic device according to an embodiment of the present disclosure.

### DESCRIPTION OF EMBODIMENTS

In the embodiments of the present disclosure, unless otherwise specified, the character “/” indicates that associated objects are in an “or” relationship. For example, A/B may represent A or B. The term “and/or” describes an association relationship between associated objects and indicates that three relationships may exist. For example, A and/or B may represent the following three cases: A alone, both A and B, and B alone.

It should be noted that in the embodiments of the present disclosure, terms such as “first” and “second” are merely used for a purpose of distinction in description, and should not be understood as an indication or implication of relative importance, an implicit indication of a quantity of indicated technical features, or an indication or implication of a sequence.

In the embodiments of the present disclosure, “at least one” means one or more, and “a plurality of” means two or more. In addition, “at least one of the following items (pieces)” or a similar expression thereof indicates any combination of these items, which may include a single item (piece) or any combination of a plurality of items (pieces). For example, at least one of A, B, or C may represent A, B, C, A and B, A and C, B and C, or A, B, and C. Each of A, B, and C may be an element or a set including one or more elements.

In the embodiments of the present disclosure, “example”, “in some embodiments”, “in another embodiment”, or the like is used to represent giving an example, an illustration, or a description. Any embodiment or design scheme described as an “example” in the present disclosure should not be explained as being more preferred or having more advantages than another embodiment or design scheme. Exactly, the word “example” is used to present a concept in a specific manner.

In the embodiments of the present disclosure, “of”, “relevant”, and “corresponding” may sometimes be used interchangeably. It should be noted that when a difference between them is not emphasized, they have a same meaning. In the embodiments of the present disclosure, communication and transmission may sometimes be used interchangeably. It should be noted that when a difference between them is not emphasized, they have a same meaning. For example, transmission may include transmitting and/or receiving, and may be in a form of a noun or verb.

In the embodiments of the present disclosure, equal to may be used with greater than, applicable to the technical solution adopted for greater than; or may be used with less than, applicable to the technical solution adopted for less than. It should be noted that equal to cannot be used with less than when used with greater than; and cannot be used with greater than when used with less than.

The following describes some terms in the embodiments of the present disclosure to facilitate understanding by those skilled in the art.

### 1. Terminal Device

The terminal device in the embodiments of the present disclosure is a device having a wireless transceiving function, and may be referred to as a terminal, user equipment (UE), a mobile station (MS), a mobile terminal (MT), an access terminal device, a vehicle-mounted terminal device, an industrial control terminal device, a UE unit, a UE station, a mobile platform, a remote station, a remote terminal device, a mobile device, a UE terminal device, a wireless communication device, a UE proxy, a UE apparatus, or the like. The terminal device may be stationary or mobile. It should be noted that the terminal device may support at least one wireless communication technology, such as long term evolution (LTE) and new radio (NR). For example, the terminal device may be a mobile phone, a tablet computer, a desktop computer, a notebook computer, an all-in-one machine, a vehicle-mounted terminal, a virtual reality (VR) terminal device, an augmented reality (AR) terminal device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a wearable device, a terminal device in a future mobile communication network, a terminal device in a future evolved public land mobile network (PLMN), or the like. In some embodiments of the present disclosure, the terminal device may alternatively be an apparatus having a transceiving function, such as a chip system. The chip system may include a chip, and may further include another discrete component.

### 2. Network Device

The network device in the embodiments of the present disclosure is a device that provides a wireless communication function for a terminal device, and may also be referred to as an access network device, a radio access network (RAN) device, or the like. The network device may support at least one wireless communication technology, such as LTE and NR. For example, the network device includes but is not limited to a gNodeB (gNB) in a 5G mobile communication system, an evolved NodeB (eNB), a radio network controller (RNC), a NodeB (NB), a base station controller (BSC), a base transceiver station (BTS), a home base station (such as a home eNB or a home NB (HNB)), a baseband unit (BBU), a transmitting and receiving point (TRP), a transmitting point (TP), and a mobile switching center. Alternatively, the network device may be a radio controller, a centralized unit (CU), and/or a distributed unit (DU) in a cloud RAN (CRAN) scenario; or may be a relay station, an access point, a vehicle-mounted device, a terminal device, a wearable device, a network device in future mobile communication, a network device in a future evolved PLMN, or the like. In some embodiments, the network device may alternatively be an apparatus that provides a wireless communication function for a terminal device, such as a chip system. For example, the chip system may include a chip, and may further include another discrete component.

### 3. Serving Cell

In a 5G network, because there are many spectrum resources, for example, frequency bands such as 1 GHz, 2 GHZ, 4 GHZ, 6 GHZ, and 26 GHz, carriers or cells corresponding to some frequency bands (such as 4 GHZ, 6 GHZ, and 26 GHZ) of a base station can be deactivated if possible when a network load is low, carriers or cells corresponding to other frequency bands (such as 1 GHz and 2 GHZ) can be activated if possible, and the deactivated carriers or cells can be activated as needed, to implement NES. That is, when the network load is low, the base station may not use some carriers or cells to carry data, but use other carriers or cells to carry data. In other words, NES can be implemented by activating/deactivating some carriers. However, this is generally possible only when the network load is low.

A carrier or cell that is not deactivated may be referred to as an anchor carrier or anchor cell, a first-type carrier or first-type cell, or a primary component carrier (PCC) or primary cell (PCell). In general, the anchor carrier is a PCell or a primary secondary cell (PSCell) in carrier aggregation (CA) or dual connection (DC). Therefore, switching between a non-anchor carrier and the anchor carrier may be switching between PCells or PSCells. For ease of description, the anchor cell, first-type cell, and PCell are collectively referred to as the serving cell in this specification.

### 4. Target Cell

To support access and mobility of a terminal device, at least one carrier or cell still needs to transmit a measurement reference signal (synchronization signal block, tracking reference signal, or the like). Such a carrier or cell may be referred to as a non-anchor carrier or non-anchor cell, a second-type carrier or second-type cell, or a secondary component carrier (SCC) or secondary cell (SCell). The non-anchor carrier may be different from a SCell in CA or DC. The non-anchor carrier may be a PCell or PSCell in CA or DC. If the non-anchor carrier is understood as the SCell in CA or DC, switching between the non-anchor carrier and the anchor carrier may be understood as adding, deleting, or modifying the SCell in CA or DC. Use of the anchor carrier and the non-anchor carrier is simpler than CA or DC, has a low requirement on a backhaul network, and does not require UE to simultaneously receive signals of a plurality of carriers, which is easier to implement. For ease of description, the non-anchor cell, second-type cell, or SCell are collectively referred to as the target cell in this specification.

When the terminal device expects to switch from the serving cell to the target cell, to assist the terminal device in successfully switching, the target cell needs to transmit a measurement reference signal for supporting the terminal device to complete measurement. To implement NES, duration for which the target cell is activated needs to be as short as possible. Therefore, it is challenging to ensure NES of the target cell and successful switching of the terminal device.

In view of the foregoing problem, the embodiments of the present disclosure provide a communication method. A terminal device can complete measurement and report measurement results for multiple target cells in a short time. A network device can select an appropriate target cell based on the measurement results and indicate the appropriate target cell to the terminal device such that the terminal device can rapidly switch from a serving cell to the appropriate target cell.

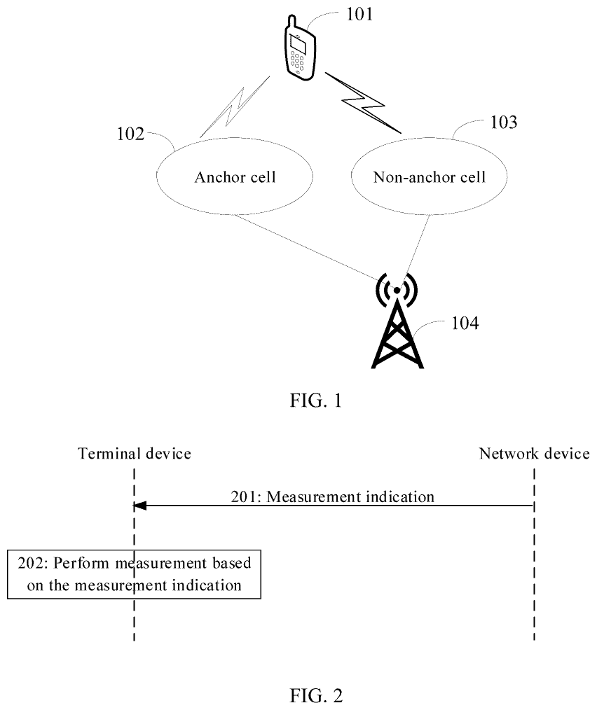

The following describes the communication method provided in the embodiments of the present disclosure with reference to FIG. 1 to FIG. 5.

FIG. 1 is a diagram of a network architecture of a communication system according to an embodiment of the present disclosure.

Referring to FIG. 1, the communication system includes a terminal device 101, an anchor cell 102, a non-anchor cell 103, and a base station 104.

In the embodiments of the present disclosure, the anchor cell 102 may be represented by a serving cell, source cell, or current cell, and the non-anchor cell 103 may be represented by a target cell, non-serving cell, or candidate cell. Because for the given terminal device 101, the serving cell, source cell, or current cell before the terminal device 101 performs switching may be the foregoing cell or carrier that is not deactivated, the anchor cell 102 may be the serving cell, source cell, or current cell. Because the target cell, non-serving cell, or candidate cell to which the terminal device switches may be the foregoing cell or carrier that is activated on demand, the non-anchor cell 103 may be the target cell, non-serving cell, or candidate cell.

It should be noted that the anchor cell 102 and the non-anchor cell 103 may belong to a same base station or may be configured on different base stations. If the anchor cell 102 and the non-anchor cell 103 belong to the same base station, the anchor cell 102 may be referred to as a PCell or PCC, and the non-anchor cell 103 may be referred to as an SCell or SCC. If the anchor cell 102 and the non-anchor cell 103 belong to different base stations, the anchor cell 102 may be referred to as a PCell or PCC, and the non-anchor cell 103 may also be referred to as a PCell or PCC.

When the anchor cell 102 is used as a subject in the present disclosure, it can be understood that the base station corresponding to the anchor cell 102 is used as a subject. In other words, the anchor cell 102 can be replaced by the base station corresponding to the anchor cell 102. Similarly, when the non-anchor cell 103 is used as a subject in the present disclosure, it can be understood that the base station corresponding to the non-anchor cell 103 is used as a subject. In other words, the non-anchor cell 103 can be replaced by the base station corresponding to the non-anchor cell 103.

Referring to FIG. 1 again, the base station 104 may be configured with both the non-anchor cell 103 and the anchor cell 102. When a network load is low, the terminal device 101 can transmit service data on the anchor cell 102, and the base station 104 can deactivate the non-anchor cell 103 to implement NES. When the network load is high, the non-anchor cell 103 can be activated. That is, the terminal device 101 can access a network through the non-anchor cell 103 to support data load balancing.

FIG. 2 is a schematic flowchart of an embodiment of a communication method according to the present disclosure. Through the embodiment shown in FIG. 2, a terminal device can complete measurement for a target cell. The method specifically includes the following steps:

In step 201, a network device transmits a measurement indication to a terminal device. Correspondingly, the terminal device receives the measurement indication sent by the network device.

Specifically, the network device may transmit the measurement indication to the terminal device according to requirements. The measurement indication may be sent to the terminal device through a serving cell. The requirements may include the following two scenarios:

### Scenario 1

Service terminated by the terminal device.

For a service terminated by the terminal device, such as a wake-up service or a paging service, when the network device is ready to wake up or page the terminal device through the serving cell, the network device may transmit the measurement indication to the terminal device to indicate the terminal device to measure the target cell.

### Scenario 2

Service initiated by the terminal device.

For a service initiated by the terminal device, such as a service initiated by the terminal device for random access, the terminal device performs random access to the serving cell.

For example, in a 4-step random access procedure, the network device may transmit the measurement indication to the terminal device if the network device receives a message 1 (Msg1) or a Msg3 sent by the terminal device. The Msg1 and Msg3 are the first and third messages in the 4-step random access procedure. The Msg1 may be a PRACH. The Msg3 may include an RRCSetupRequest message. It can be understood that the Msg1 or Msg3 may alternatively include another RRC message. In general, the Msg3 is carried in a physical uplink shared channel (PUSCH).

For example, in a 2-step random access procedure, the network device may transmit the measurement indication to the terminal device if the network device receives a MsgA sent by the terminal device. The MsgA is the first message in the 2-step random access procedure. The MsgA may include a PRACH and an RRCSetupRequest message. It can be understood that the MsgA may alternatively include another RRC message. In general, the PRACH consists of a random access occasion (RO) and a preamble.

It can be understood that after transmitting the measurement indication to the terminal device through the serving cell, the network device may activate one or more target cells and transmit measurement reference signals of the target cells. Correspondingly, the terminal device may complete measurement based on the measurement reference signals of the target cells.

In step 202, after receiving the measurement indication, the terminal device performs measurement based on the measurement indication.

Specifically, after receiving the measurement indication, the terminal device may measure the activated target cell based on the measurement indication such that the activated target cell can be discovered. For example, the activated target cell may be discovered through cell search and measurement.

In the embodiments of the present disclosure, during the measurement, the terminal device ensures that the measurement is performed only when the target cell is activated. In this way, measurement can be completed for the target cell and NES can be facilitated.

The following specifically describes the communication method according to the embodiments of the present disclosure with reference to different cases in the measurement scenarios.

### Embodiment 1

The measurement indication is carried in a wake-up signal, paging indication, page, Msg2, Msg4, or MsgB.

The wake-up signal, paging indication, page, Msg2, Msg4, or MsgB may be sent by the network device to the terminal device through the serving cell.

The 4-step random access procedure is used as an example. The Msg2 and Msg4 are the second and fourth messages in the 4-step random access procedure. The Msg2 may include a random access response (RAR) message. The Msg4 may include an RRCSetup message, an RRCResume message, or an RRCReestablishment message. It can be understood that the Msg2 or the Msg4 may alternatively include another RRC message. In general, the Msg2 or Msg4 is carried in a physical downlink shared channel (PDSCH).

For example, in the 2-step random access procedure, the MsgB may be sent by the network device to the terminal device through the serving cell. The MsgB is the second message in the 2-step random access procedure. The MsgB may include a RAR message, an RRCSetup message, an RRCResume message, or an RRCReestablishment message. It can be understood that the MsgB may alternatively include another RRC message. In general, the MsgB is carried in a PDSCH.

If the measurement indication is carried in the wake-up signal, paging indication, or page, because the terminal device is in idle mode and the network device does not know coverage of which target cells the terminal device falls within, the network device may activate all target cells controlled by the network device after transmitting the measurement indication through the wake-up signal, paging indication, or page.

If the measurement indication is carried in the Msg2, the network device may activate at least one or all of the target cells controlled by the network device. If the network device activates at least one of the target cells controlled by the network device, because the terminal device is in idle mode, the network device may roughly estimate, based on the Msg1 sent by the terminal device, coverage of which target cells the terminal device falls within.

If the measurement indication is carried in the Msg4, the network device may activate at least one or all of the target cells controlled by the network device. If the network device activates at least one of the target cells controlled by the network device, because the terminal device is in idle mode, the network device may roughly estimate, based on the Msg1 and Msg3 sent by the terminal device, coverage of which target cells the terminal device falls within.

If the measurement indication is carried in the MsgB, the network device may activate at least one or all of target cells controlled by the network device. If the network device activates at least one of the target cells controlled by the network device, because the terminal device is in idle mode, the network device may roughly estimate, based on the MsgA sent by the terminal device, coverage of which target cells the terminal device falls within.

### Embodiment 2

The measurement indication is carried in a PDCCH.

The measurement indication may be carried in a PDCCH of the serving cell.

If the terminal device is in connected mode, the network device may carry the measurement indication through the PDCCH such that the network device can rapidly transmit the measurement indication. In this way, the terminal device can rapidly receive the measurement indication and perform measurement. In specific implementation, the PDCCH may also be a PDCCH order. Because the PDCCH order itself may trigger the terminal device to initiate a random access procedure, the measurement indication may be carried in the PDCCH order, to reduce modification of a protocol.

### Embodiment 3

The measurement indication is carried in RRC signaling.

If the terminal device is in connected mode, for example, the terminal device has established a connection to the serving cell, the network device may carry the measurement indication through RRC signaling of the serving cell. Because the RRC signaling is reliable, carrying the measurement indication through the RRC signaling can improve reliability of transmitting the measurement indication.

### Embodiment 4

The measurement indication is carried in a MAC CE.

If the terminal device is in connected mode, for example, the terminal device has established a connection to the serving cell, the network device may carry the measurement indication through a MAC CE. Because the MAC CE can give consideration to both rapidity and reliability, carrying the measurement indication through the MAC CE can improve reliability of transmitting the measurement indication while ensuring that the measurement indication can be rapidly sent to the terminal device.

### Embodiment 5

The terminal device performs measurement based on a measurement object configuration.

The network device may notify, through the measurement object configuration, the terminal device of target cells that need to be measured. The measurement object configuration may be sent by the network device to the terminal device through the serving cell. The measurement object configuration may include a cell identifier or a physical cell identifier. In specific implementation, the network device may configure cell identifiers or physical cell identifiers to notify the terminal device of measurement reference signals sent by different target cells. A sequence of the measurement reference signals may be generated through the cell identifiers or physical cell identifiers.

Optionally, the measurement object configuration may alternatively include a cell frequency such that the terminal device can switch from the serving cell by distinguishing the cell frequency. The target cell is deployed at a different frequency from the serving cell. This can avoid interference from the target cell to the serving cell and helps the target cell better share service traffic.

In addition, when the network device transmits the measurement object configuration, the measurement object configuration may be carried in SI, for example, the measurement object configuration may be broadcast through SI of the serving cell. With the broadcasting through the SI of the serving cell, the terminal device can perform measurement after receiving the wake-up signal, paging indication, page, Msg2, Msg4, or MsgB and before entering connected mode. This can improve efficiency of switching between cells.

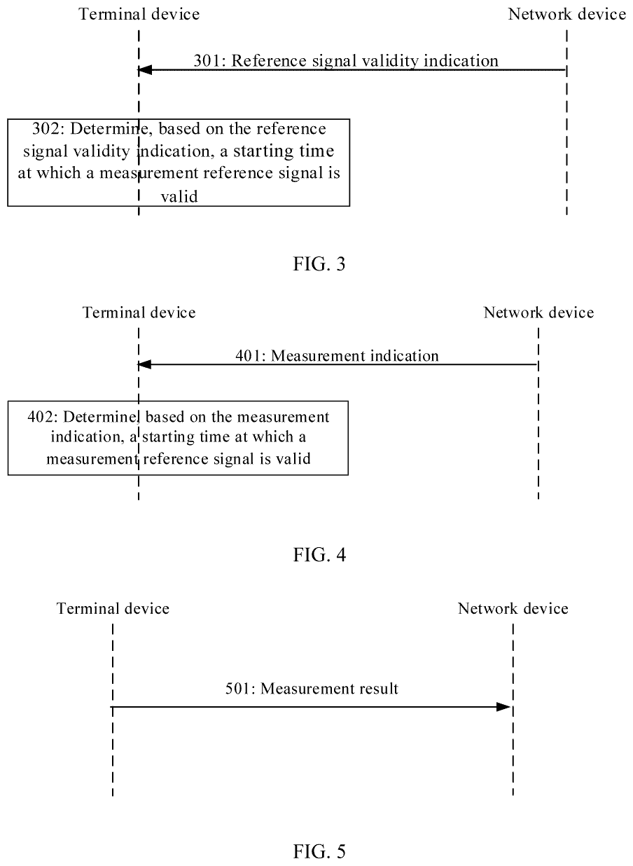

FIG. 3 is a schematic flowchart of another embodiment of a communication method according to the present disclosure. Through the embodiment shown in FIG. 3, a starting time at which a measurement reference signal is valid can be determined. The method specifically includes the following steps:

In step 301, a network device transmits a reference signal validity indication to a terminal device. Correspondingly, the terminal device receives the reference signal validity indication sent by the network device.

Specifically, the terminal device considers that the measurement reference signal is valid only if the signal is detected after the starting time at which the measurement reference signal is valid. Therefore, the network device can transmit the measurement reference signal after the starting time at which the measurement reference signal is valid. This is beneficial to NES.

To notify the terminal device of the starting time at which the measurement reference signal is valid, the network device may transmit the reference signal validity indication to the terminal device.

In step 302, the terminal device determines, based on the reference signal validity indication, the starting time at which the measurement reference signal is valid.

Specifically, after receiving the reference signal validity indication, the terminal device may determine, based on the reference signal validity indication, the starting time at which the measurement reference signal is valid. Because it takes time for the target cell to be activated, the reference signal validity indication may be used to notify the terminal device whether it takes time for the network device to activate the target cell. After the terminal device is notified through the reference signal validity indication that it takes time for the network device to activate the target cell, the terminal device may not perform measurement during this period of time such that the terminal device can avoid invalid measurement. This can save power consumption of the terminal device and improve measurement efficiency.

In specific implementation, if the terminal device is notified through the reference signal validity indication that there is a time gap, that is, if the target cell has not been activated, it takes time for the network device to activate the target cell. In this case, the terminal device may determine that the staring time at which the measurement reference signal is valid is a time at which a first measurement reference signal is transmitted after the time gap from a time of receiving the reference signal validity indication. Because the network device uses the time at which the first measurement reference signal is transmitted after the time gap from a time at which the reference signal validity indication is transmitted as a time at which the measurement reference signal is transmitted, the measurement reference signal can be transmitted as soon as possible, and the terminal device can start measurement at the time at which the first measurement reference signal is transmitted after the time gap from the time of receiving the reference signal validity indication. This can avoid invalid measurement.

If the terminal device is notified through the reference signal validity indication that there is no time gap, that is, if the target cell has been activated, the network device may transmit the measurement reference signal at a time at which the first measurement reference signal is transmitted such that the measurement reference signal can be transmitted as soon as possible. In this case, the terminal device may determine that the starting time at which the measurement reference signal is valid is the time at which the first measurement reference signal is transmitted. This can avoid invalid measurement.

The time gap may be predefined in a protocol. This can save signaling overheads. Alternatively, the time gap may be carried in a semi-static configuration. This can achieve flexibility and low signaling overheads. Alternatively, the time gap may be carried in the reference signal validity indication. This can improve flexibility. Alternatively, because signaling overheads increase if the reference signal validity indication carries the time gap, to reduce the signaling overheads, only an index of the target time gap may be carried in the reference signal validity indication, and candidate values and indexes corresponding to the candidate values may be carried in the semi-static configuration such that the target time gap can be found through the index. This can achieve flexibility and low signaling overheads.

The following specifically describes the communication method according to the embodiments of the present disclosure with reference to different manners of carrying the reference signal validity indication.

### Embodiment 6

The reference signal validity indication is carried in a wake-up signal, paging indication, page, Msg2, Msg4, or MsgB.

If the terminal device is in idle mode, the network device may carry the reference signal validity indication in the wake-up signal, paging indication, page, Msg2, Msg4, or MsgB through the serving cell, and the reference signal validity indication does not need to be carried through additional signaling. This can reduce the signaling overheads.

### Embodiment 7

The reference signal validity indication is carried in a PDCCH.

If the terminal device is in connected mode, the network device may carry the reference signal validity indication in the PDCCH through the serving cell such that the reference signal validity indication can be rapidly sent.

Preferably, the PDCCH may also be a PDCCH order. This can reduce modification of a protocol.

### Embodiment 8

The reference signal validity indication is carried in RRC signaling.

If the terminal device is in connected mode, the network device may carry the reference signal validity indication in the RRC signaling through the serving cell. This can improve reliability of transmitting the reference signal validity indication.

### Embodiment 9

The reference signal validity indication is carried in a MAC CE.

If the terminal device is in connected mode, the network device may carry the reference signal validity indication in the MAC CE through the serving cell. In this way, the reference signal validity indication can be rapidly sent, and reliability of transmitting the reference signal validity indication can be improved.

FIG. 4 is a schematic flowchart of another embodiment of a communication method according to the present disclosure. Through the embodiment shown in FIG. 4, a starting time at which a measurement reference signal is valid can be determined. The method specifically includes the following steps:

In step 401, a network device transmits a measurement indication to a terminal device. Correspondingly, the terminal device receives the measurement indication sent by the network device.

For specific implementation of step 401, reference may be made to the relevant description in step 201. Details are not described herein again.

In step 402, the terminal device determines, based on the measurement indication, the starting time at which the measurement reference signal is valid.

After receiving the measurement indication, the terminal device determines, based on the measurement indication, the starting time at which the measurement reference signal is valid.

In this way, regardless of whether a target cell is activated, provided that the measurement indication is received, the terminal device can determine, based on a same time gap, the starting time at which the measurement reference signal is valid. This can save overheads of transmitting a time gap indication (for example, a reference signal validity indication). The time gap may be predefined in a protocol or carried in a semi-static configuration.

FIG. 5 is a schematic flowchart of another embodiment of a communication method according to the present disclosure. Through the embodiment shown in FIG. 5, a measurement result can be reported to a network device. The method specifically includes the following steps: In step 501, a terminal device reports a measurement result to a network device.

Specifically, after measuring a target cell, the terminal device may actively report the measurement result obtained after the measurement to the network device. In this scenario, there is no need to adopt a manner of passively reporting the measurement result based on event triggering such that the measurement result can be rapidly reported. This can improve efficiency of switching between cells.

The following specifically describes the communication method according to the embodiments of the present disclosure with reference to different manners of reporting the measurement result.

### Embodiment 10

The terminal device reports the measurement result through a Msg1 or MsgA.

For example, in a 4-step random access procedure, if a serving cell of the network device indicates, through a wake-up signal, paging indication, or page, the terminal device to measure the target cell, because the terminal device is in idle mode, the terminal device may report the measurement result through the Msg1 after obtaining the measurement result. It can be understood that the serving cell of the network device may indicate an identifier of the target cell in a Msg2 such that after receiving the identifier of the target cell in the Msg2, the terminal device can transmit a Msg3 to the target cell corresponding to the identifier based on the identifier of the target cell, to switch to the target cell corresponding to the identifier as soon as possible.

For example, in a 2-step random access procedure, if a serving cell of the network device indicates, through a wake-up signal, paging indication, or page, the terminal device to measure the target cell, because the terminal device is in idle mode, the terminal device may report the measurement result through the MsgA after obtaining the measurement result. It can be understood that the serving cell of the network device may indicate an identifier of the target cell in a MsgB such that after receiving the identifier of the target cell in the MsgB, the terminal device can transmit a MsgC to the target cell corresponding to the identifier based on the identifier of the target cell, to switch to the target cell corresponding to the identifier as soon as possible. The MsgC is the third message in the 2-step random access procedure. The MsgC may include an RRCReconfiguration message. It can be understood that the MsgC may alternatively include another RRC message. In general, the MsgC is carried in a PDSCH.

### Embodiment 11

The terminal device reports the measurement result through a Msg3.

If a serving cell of the network device indicates, through a Msg2, the terminal device to measure the target cell, because the terminal device is in idle mode, the terminal device may report the measurement result through the Msg3 after obtaining the measurement result. It can be understood that the serving cell of the network device may indicate an identifier of the target cell in a Msg4 such that after receiving the identifier of the target cell in the Msg4, the terminal device can transmit a Msg5 to the target cell corresponding to the identifier based on the identifier of the target cell, to switch to the target cell corresponding to the identifier as soon as possible. The Msg5 may be the fifth message in a 4-step random access procedure, namely the first message sent by the terminal device to the network device after the random access procedure is completed. The Msg5 may include an RRCSetupComplete message, an RRCResumeComplete message, or an RRCReestablishmentComplete message. It can be understood that the Msg5 may alternatively include another RRC message. In general, the Msg5 is carried in a PUSCH.

### Embodiment 12

The terminal device reports the measurement result through a Msg5 or MsgC.

For example, in a 4-step random access procedure, if a serving cell of the network device indicates, through a Msg4, the terminal device to measure the target cell, because the terminal device is in idle mode, the terminal device may report the measurement result through the Msg5 after obtaining the measurement result. It can be understood that the serving cell of the network device may indicate an identifier of the target cell in a message 6 (Msg6) based on capability information of the terminal device in the Msg5. Because the terminal device is in connected mode, after receiving the identifier of the target cell in the Msg6, the terminal device may directly switch to the target cell corresponding to the identifier based on the identifier of the target cell such that rapid switching between cells can be implemented. The Msg6 may be the sixth message in the 4-step random access procedure. The Msg6 may include an RRCReconfiguration message. It can be understood that the Msg6 may alternatively include another RRC message. In general, the Msg6 is carried in a PDSCH.

For example, in a 2-step random access procedure, if a serving cell of the network device indicates, through a MsgB, the terminal device to measure the target cell, because the terminal device is in idle mode, the terminal device may report the measurement result through the MsgC after obtaining the measurement result. It can be understood that the serving cell of the network device may indicate an identifier of the target cell in a message D (MsgD) based on capability information of the terminal device in the MsgC. Because the terminal device is in connected mode, after receiving the identifier of the target cell in the MsgD, the terminal device may directly switch to the target cell corresponding to the identifier based on the identifier of the target cell such that rapid switching between cells can be implemented. The MsgD may include an RRCReconfiguration message. It can be understood that the MsgD may alternatively include another RRC message. In general, the MsgD is carried in a PDSCH.

### Embodiment 13

The terminal device reports the measurement result through UCI.

If the terminal device is in connected mode, the terminal device may report the measurement result through UCI carried in a physical uplink control channel (PUCCH) or a PUSCH such that the measurement result can be rapidly reported.

### Embodiment 14

The terminal device reports the measurement result through RRC signaling.

If the terminal device is in connected mode, the terminal device may report the measurement result through RRC signaling such that reliability of transmitting the measurement result can be improved.

### Embodiment 15

The terminal device reports the measurement result through a MAC CE.

If the terminal device is in connected mode, the terminal device may report the measurement result through a MAC CE such that the measurement result can be rapidly reported to the network device and reliability of transmitting the measurement result can be improved.

The foregoing embodiments may be used independently or may be combined with each other to achieve different technical effects.

In the foregoing embodiments provided in the present disclosure, the communication method provided in the embodiments of the present disclosure is introduced from perspectives of the network device and the terminal device as execution bodies. In order to implement the functions in the communication method provided in the foregoing embodiments of the present disclosure, the terminal device and the network device may include a hardware structure and/or a software module to implement the functions in the form of the hardware structure, the software module, or the hardware structure in combination with the software module. Whether one of the functions is implemented in the form of the hardware structure, the software module, or the hardware structure in combination with the software module depends on particular applications and design constraints of the technical solutions.

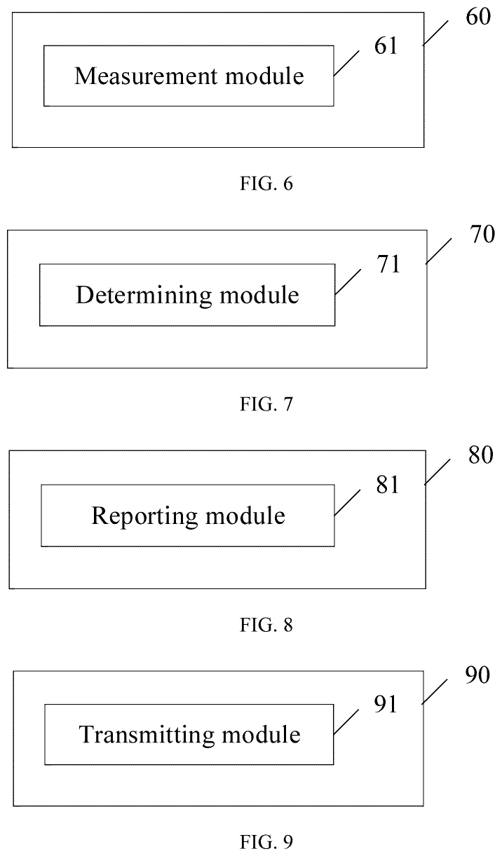

FIG. 6 is a schematic diagram of a communication apparatus 60 according to an embodiment of the present disclosure, which may include a measurement module 61.

The measurement module 61 is configured to perform measurement based on a measurement indication.

In a possible implementation, the measurement indication is carried in a wake-up signal, a paging indication, a page, a Msg2, a Msg4, or a MsgB.

In a possible implementation, the measurement indication is carried in a PDCCH. In a possible implementation, the PDCCH is a PDCCH order.

In a possible implementation, the measurement indication is carried in RRC signaling.

In a possible implementation, the measurement indication is carried in a MAC CE.

In a possible implementation, the measurement module 61 is further configured to perform measurement based on a measurement object configuration.

In a possible implementation, the measurement object configuration includes a cell identifier or a physical cell identifier.

In a possible implementation, the measurement object configuration includes a cell frequency.

In a possible implementation, the measurement object configuration is carried in SI.

In a possible implementation, the communication apparatus 60 may be a chip or a terminal device.

FIG. 7 is a schematic diagram of a communication apparatus 70 according to an embodiment of the present disclosure, which may include a determining module 71.

The determining module 71 is configured to determine a time at which a measurement reference signal is valid.

In a possible implementation, the determining module 71 is specifically configured to determine, based on a reference signal validity indication, the starting time at which the measurement reference signal is valid.

In a possible implementation, the determining module 71 is specifically configured to: if the reference signal validity indication indicates that there is a time gap, determine that the starting time at which the measurement reference signal is valid is a time at which the first measurement reference signal is transmitted after the time gap; or

if the reference signal validity indication indicates that there is no time gap, determine that the starting time at which the measurement reference signal is valid is a time at which the first measurement reference signal is transmitted.

In a possible implementation, the time gap is predefined.

Alternatively, the time gap is carried in a semi-static configuration.

Alternatively, the time gap is carried in the reference signal validity indication.

Alternatively, the time gap is indicated in the reference signal validity indication in candidate values. The candidate values are carried in the semi-static configuration.

In a possible implementation, the reference signal validity indication is carried in a wake-up signal, a paging indication, a page, a Msg2, a Msg4, or a MsgB.

In a possible implementation, the reference signal validity indication is carried in a PDCCH.

In a possible implementation, the PDCCH is a PDCCH order.

In a possible implementation, the reference signal validity indication is carried in RRC signaling.

In a possible implementation, the reference signal validity indication is carried in a MAC CE.

In a possible implementation, the determining module 71 is specifically configured to determine, based on a measurement indication, that the starting time at which the measurement reference signal is valid is a time at which the first measurement reference signal is transmitted after a time gap.

In a possible implementation, the time gap is predefined.

Alternatively, the time gap is carried in a semi-static configuration.

In a possible implementation, the communication apparatus 70 may be a chip or a terminal device.

FIG. 8 is a schematic diagram of a communication apparatus 80 according to an embodiment of the present disclosure, which may include a reporting module 81.

The reporting module 81 is configured to report a measurement result.

In a possible implementation, the reporting module 81 is specifically configured to report the measurement result through a PRACH or a MsgA.

In a possible implementation, the reporting module 81 is specifically configured to report the measurement result through a Msg3 or a MsgB.

In a possible implementation, the reporting module 81 is specifically configured to report the measurement result through a Msg5 or a MsgC.

In a possible implementation, the reporting module 81 is specifically configured to report the measurement result through UCI.

In a possible implementation, the reporting module 81 is specifically configured to report the measurement result through RRC signaling.

In a possible implementation, the reporting module 81 is specifically configured to report the measurement result through a MAC CE.

In a possible implementation, the communication apparatus 80 may be a chip or a terminal device.

FIG. 9 is a schematic diagram of a communication apparatus 90 according to an embodiment of the present disclosure, which may include a transmitting module 91.

The transmitting module 91 is configured to transmit a measurement indication.

In a possible implementation, the transmitting module 91 is specifically configured to transmit the measurement indication through a wake-up signal, a paging indication, a page, a Msg2, a Msg4, or a MsgB.

In a possible implementation, the transmitting module 91 is specifically configured to transmit the measurement indication through a PDCCH.

In a possible implementation, the PDCCH is a PDCCH order.

In a possible implementation, the transmitting module 91 is specifically configured to transmit the measurement indication through RRC signaling.

In a possible implementation, the transmitting module 91 is specifically configured to transmit the measurement indication through a MAC CE.

In a possible implementation, the transmitting module 91 is further configured to transmit a measurement object configuration.

In a possible implementation, the measurement object configuration includes a cell identifier or a physical cell identifier.

In a possible implementation, the measurement object configuration includes a cell frequency.

In a possible implementation, the measurement object configuration is carried in SI.

In a possible implementation, the communication apparatus 90 may be a chip or a network device.

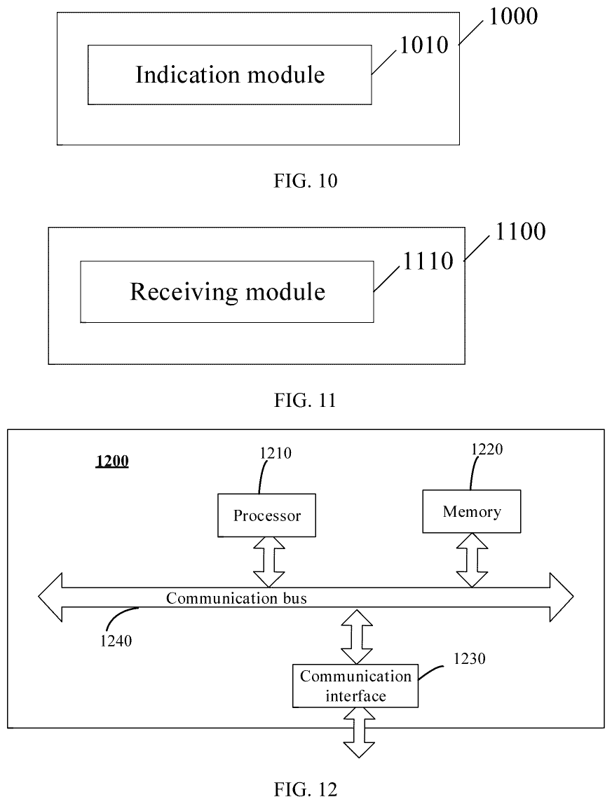

FIG. 10 is a schematic diagram of a communication apparatus 1000 according to an embodiment of the present disclosure, which may include an indication module 1010.

The indication module 1010 is configured to indicate a time at which a measurement reference signal is valid.

In a possible implementation, the indication module 1010 is specifically configured to indicate, through a reference signal validity indication, the starting time at which the measurement reference signal is valid.

In a possible implementation, the indication module 1010 is specifically configured to: if the reference signal validity indication indicates that there is a time gap, indicate that the starting time at which the measurement reference signal is valid is a time at which the first measurement reference signal is transmitted after the time gap; or
if the reference signal validity indication indicates that there is no time gap, indicate that the starting time at which the measurement reference signal is valid is a time at which the first measurement reference signal is transmitted.

In a possible implementation, the time gap is predefined.

Alternatively, the time gap is carried in a semi-static configuration.

Alternatively, the time gap is carried in the reference signal validity indication.

Alternatively, the time gap is indicated in the reference signal validity indication in candidate values. The candidate values are carried in the semi-static configuration.

In a possible implementation, the reference signal validity indication is carried in a wake-up signal, a paging indication, a page, a Msg2, a Msg4, or a MsgB.

In a possible implementation, the reference signal validity indication is carried in a PDCCH.

In a possible implementation, the PDCCH is a PDCCH order.

In a possible implementation, the reference signal validity indication is carried in RRC signaling.

In a possible implementation, the reference signal validity indication is carried in a MAC CE.

In a possible implementation, the indication module 1010 is specifically configured to indicate, through a measurement indication, that the starting time at which the measurement reference signal is valid is a time at which the first measurement reference signal is transmitted after a time gap.

In a possible implementation, the time gap is predefined.

Alternatively, the time gap is carried in a semi-static configuration.

In a possible implementation, the communication apparatus 1000 may be a chip or a network device.

FIG. 11 is a schematic diagram of a communication apparatus 1100 according to an embodiment of the present disclosure, which may include a receiving module 1110.

The receiving module 1110 is configured to receive a measurement result.

In a possible implementation, the receiving module 1110 is specifically configured to receive the measurement result through a PRACH or a MsgA.

In a possible implementation, the receiving module 1110 is specifically configured to receive the measurement result through a Msg3 or a MsgB.

In a possible implementation, the receiving module 1110 is specifically configured to receive the measurement result through a Msg5 or a MsgC.

In a possible implementation, the receiving module 1110 is specifically configured to receive the measurement result through UCI.

In a possible implementation, the receiving module 1110 is specifically configured to receive the measurement result through RRC signaling.

In a possible implementation, the receiving module 1110 is specifically configured to receive the measurement result through a MAC CE.

In a possible implementation, the communication apparatus 1100 may be a chip or a network device.

FIG. 12 is a schematic diagram of a communication apparatus 1200 according to an embodiment of the present disclosure. The communication apparatus 1200 may include at least one processor and at least one memory communicatively connected to the processor. The communication apparatus 1200 may be a network device or a terminal device. The memory stores a program instruction executable by the processor. If the communication apparatus 1200 is the network device, the processor calls the program instruction to perform the actions performed by the network device in the communication method provided in the embodiments of the present disclosure. If the communication apparatus 1200 is the terminal device, the processor calls the program instruction to perform the actions performed by the terminal device in the communication method provided in the embodiments of the present disclosure.

As shown in FIG. 12, the communication apparatus 1200 may be in the form of a general-purpose computing device. Components of the communication apparatus 1200 may include, but are not limited to, one or more processors 1210, a memory 1220, a communication bus 1240 that connects various system components (including the memory 1220 and the processors 1210), and a communication interface 1230.

The communication bus 1240 represents one or more of several types of bus architectures, including a memory bus or a memory controller, a peripheral bus, an accelerated graphics port, a processor, or a local bus using any of various bus architectures. For example, these architectures include, but are not limited to, an industry standard architecture (ISA) bus, a micro channel architecture (MAC) bus, an enhanced ISA bus, a Video Electronics Standards Association (VESA) local bus, and a peripheral component interconnect (PCI) bus.

The communication apparatus 1200 typically includes various computer system-readable media. These media may be any available media that can be accessed by the communication apparatus 1200 and include both volatile and non-volatile media, and removable and non-removable media.

The memory 1220 may include a computer system-readable medium in the form of a volatile memory, such as a random access memory (RAM) and/or a cache memory. The communication apparatus 1200 may further include other removable/non-removable and volatile/non-volatile computer system storage media. Although not shown in FIG. 12, a magnetic disk drive for reading from and writing to a removable non-volatile magnetic disk (for example, a “floppy disk”) and an optical disc drive for reading from and writing to a removable non-volatile optical disc (for example, a compact disk read-only memory (CD-ROM), a digital versatile disc read-only memory (DVD-ROM), or another optical medium) may be provided. In these cases, each drive may be connected to the communication bus 1240 through one or more data medium interfaces. The memory 1220 may include at least one program product having a set of (for example, one or more) program modules configured to implement functions in the embodiments of the present disclosure.

A program/utility having a set of (one or more) program modules may be stored in the memory 1220. The program modules include, but are not limited to, an operating system, one or more applications, other program modules, and program data. Each of these examples or some combination thereof may include an implementation of a network environment. The program modules usually implement the functions and/or methods in the embodiments described in the present disclosure.

The communication apparatus 1200 may further communicate with one or more external devices (for example, a keyboard, a pointing device, or a display), one or more devices that enable a user to interact with the communication apparatus 1200, and/or any device that enables the communication apparatus 1200 to communicate with one or more other computing devices (for example, a network card or a modem). Such communication may be performed through the communication interface 1230. In addition, the communication apparatus 1200 may communicate with one or more networks (for example, a local area network (LAN), a wide area network (WAN), and/or a public network such as the Internet) through a network adapter (not shown in FIG. 12). The network adapter may communicate with other modules of an electronic device through the communication bus 1240. It should be understood that although not shown in FIG. 12, other hardware and/or software modules may be used in combination with the communication apparatus 1200, including but not limited to microcode, a device driver, a redundant processing unit, an external disk drive array, a redundant arrays of independent disks (RAID) system, a tape driver, and a data backup storage system.

Based on the descriptions of the implementations, a person skilled in the art may clearly understand that for the purpose of convenient and brief descriptions, division into the foregoing functional modules is merely used as an example for descriptions. During actual application, the functions may be allocated to different functional modules for implementation based on a requirement. In other words, an inner structure of the apparatus is divided into different functional modules to implement all or some of the functions described above. For a specific working process of the system, apparatus, and unit described above, reference may be made to the corresponding process in the foregoing method embodiments. Details are not described herein again.

Functional units in the embodiments of the present disclosure may be integrated into one processing unit, each of the units may exist alone physically, or two or more units are integrated into one unit. The integrated unit may be implemented in a form of hardware or in a form of a software functional unit.

The integrated unit, if implemented in the form of a software functional unit and sold or used as a stand-alone product, may be stored in a computer-readable storage medium. Based on this understanding, the technical solutions in the embodiments of the present disclosure, in essence or the part contributing to the prior art, or some or all of the technical solutions may be embodied in a form of a software product. The computer software product is stored in a storage medium, and includes a plurality of instructions for enabling a computer device (which may be a personal computer, a server, a network device, or the like) or a processor to perform all or some steps of the method in the embodiments of the present disclosure. The storage medium includes any medium that can store program code, such as a flash memory, a removable hard disk, a read-only memory (ROM), a RAM, a magnetic disk, or an optical disc.

The foregoing descriptions are merely specific implementations of the present disclosure, but are not intended to limit the protection scope of the present disclosure. Any variation or replacement within the technical scope disclosed in the present disclosure shall fall within the protection scope of the present disclosure. Therefore, the protection scope of the present disclosure shall be subject to the protection scope of the claims.

1. A communication method, comprising:
performing measurement based on a measurement indication.

2. The method according to claim 1, wherein the measurement indication is carried in a wake-up signal, a paging indication, a page, a message 2 (Msg2), a message 4 (Msg4), or a message B (MsgB); or
the measurement indication is carried in a physical downlink control channel (PDCCH), a radio resource control (RRC) signaling, or a media access control control element (MAC CE).

3.-6. (canceled)

7. The method according to claim 1, further comprising:
performing measurement based on a measurement object configuration.

8. The method according to claim 7, wherein the measurement object configuration comprises a cell identifier or a physical cell identifier.

9. (canceled)

10. (canceled)

11. A communication method, comprising:
determining a starting time at which a measurement reference signal is valid.

12. The method according to claim 11, wherein said determining the starting time at which the measurement reference signal is valid comprises: determining, based on a reference signal validity indication, the starting time at which the measurement reference signal is valid.

13. The method according to claim 12, wherein said determining, based on the reference signal validity indication, the starting time at which the measurement reference signal is valid comprises:
determining that the starting time at which the measurement reference signal is valid is a time at which a first measurement reference signal is transmitted after the time gap.

14. The method according to claim 13, wherein the time gap is predefined;
the time gap is carried in a semi-static configuration;
the time gap is carried in the reference signal validity indication; or
the time gap is indicated in the reference signal validity indication in candidate values, and the candidate values are carried in the semi-static configuration.

15. The method according to claim 12, wherein the reference signal validity indication is carried in a wake-up signal, a paging indication, a page, a message 2 (Msg2), a message 4 (Msg4), or a message B (MsgB); or
the reference signal validity indication is carried in a physical downlink control channel (PDCCH), radio resource control (RRC) signaling, or a media access control control element (MAC CE).

16. (canceled)

17. The method according to claim 15, wherein the PDCCH is a PDCCH order.

18. (canceled)

19. (canceled)

20. The method according to claim 11, wherein said determining the starting time at which the measurement reference signal is valid comprises:
determining, based on a measurement indication, that the starting time at which the measurement reference signal is valid is a time at which a first measurement reference signal is transmitted after a time gap.

21. The method according to claim 20, wherein the time gap is predefined; or
the time gap is carried in a semi-static configuration.

22.-38. (canceled)

39. A communication method, comprising:
indicating a starting time at which a measurement reference signal is valid.

40. The method according to claim 39, wherein said indicating the starting time at which the measurement reference signal is valid comprises:
indicating, through a reference signal validity indication, the starting time at which the measurement reference signal is valid.

41. The method according to claim 40, wherein said indicating, through the reference signal validity indication, the starting time at which the measurement reference signal is valid comprises:
indicating that the starting time at which the measurement reference signal is valid is a nearest time at which a first measurement reference signal is transmitted after the time gap.

42. The method according to claim 41, wherein the time gap is predefined;
the time gap is carried in a semi-static configuration;
the time gap is carried in the reference signal validity indication; or
the time gap is indicated in the reference signal validity indication in candidate values, and the candidate values are carried in the semi-static configuration.

43. The method according to claim 42, wherein the reference signal validity indication is carried in a wake-up signal, a paging indication, a page, a message 2 (Msg2), a message 4 (Msg4), or a message B (MsgB); or
the reference signal validity indication is carried in a physical downlink control channel (PDCCH), radio resource control (RRC) signaling, or a media access control control element (MAC CE).

44. (canceled)

45. The method according to claim 43, wherein the PDCCH is a PDCCH order.

46. (canceled)

47. (canceled)

48. The method according to claim 39, wherein said indicating the starting time at which the measurement reference signal is valid comprises:
indicating, through a measurement indication, that the starting time at which the measurement reference signal is valid is a time at which a first measurement reference signal is transmitted after a time gap.

49. The method according to claim 48, wherein the time gap is predefined; or the time gap is carried in a semi-static configuration.

50.-61. (canceled)
